(19) United States
(12) Patent Application Publication
(10) Pub. No.: US 2026/0032000 A1
(43) Pub. Date: Jan. 29, 2026

(54) CERTIFIED IMAGE MANAGEMENT

(71) Applicant: Micron Technology, Inc., Boise, ID (US)

(72) Inventors: Giuseppe Principato, Ebersberg (DE); Giuseppe Cariello, Boise, ID (US); Sebastiano Pischedda, Novi, MI (US)

(21) Appl. No.: 19/256,981

(22) Filed: Jul. 1, 2025

Related U.S. Application Data
(60) Provisional application No. 63/676,825, filed on Jul. 29, 2024.

(51) Int. Cl. H04L 9/32; H04L 9/08

(52) U.S. Cl. CPC H04L 9/3247; H04L 9/0825

(57) ABSTRACT

A system includes an image sensor, a memory device, and a processing device operatively coupled to the memory device and to the image sensor. The image sensor, the memory device, and the processing device are integrated into an integrated circuit (IC) package for image authenticity certification. The processing device is to perform operations including causing a digital image to be captured by the image sensor. The operations further include retrieving, from the memory device, a private key. The operations further include generating, using the private key, an image signature for the digital image. The operation further include storing, in a file, the image signature and the digital image.

### REFERENCE TO RELATED APPLICATION

This application claims the priority benefit of U.S. Provisional Patent Application No. 63/676,825, filed Jul. 29, 2024, the entirety of which is incorporated herein by reference.

### TECHNICAL FIELD

Embodiments of the disclosure relate generally to image certification management, and more specifically, to methods and systems for verification and authentication of digital images.

### BACKGROUND

The proliferation of fake images complicates efforts to verify the authenticity of visual media. Verifying the authenticity of images can help to ensure that images used in various applications, such as media, legal evidence, and social platforms, are legitimate and have not been edited or generated artificially (e.g., not captured by a camera or video device).

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1A illustrates an example image authenticity certification system that includes a memory sub-system, in accordance with some embodiments of the present disclosure.

FIG. 1B is a block diagram of memory device(s) in communication with a memory sub-system controller of a memory sub-system, in accordance with one or more embodiments of the present disclosure.

FIG. 2 illustrates an example apparatus for image authenticity certification including a memory sub-system, in accordance with some embodiments of the present disclosure.

FIG. 3 is a flow diagram of an example method implementing image authenticity certification, in accordance with one or more embodiments of the present disclosure.

FIG. 4 is a block diagram of an example computer system in which embodiments of the present disclosure may operate.

### DETAILED DESCRIPTION

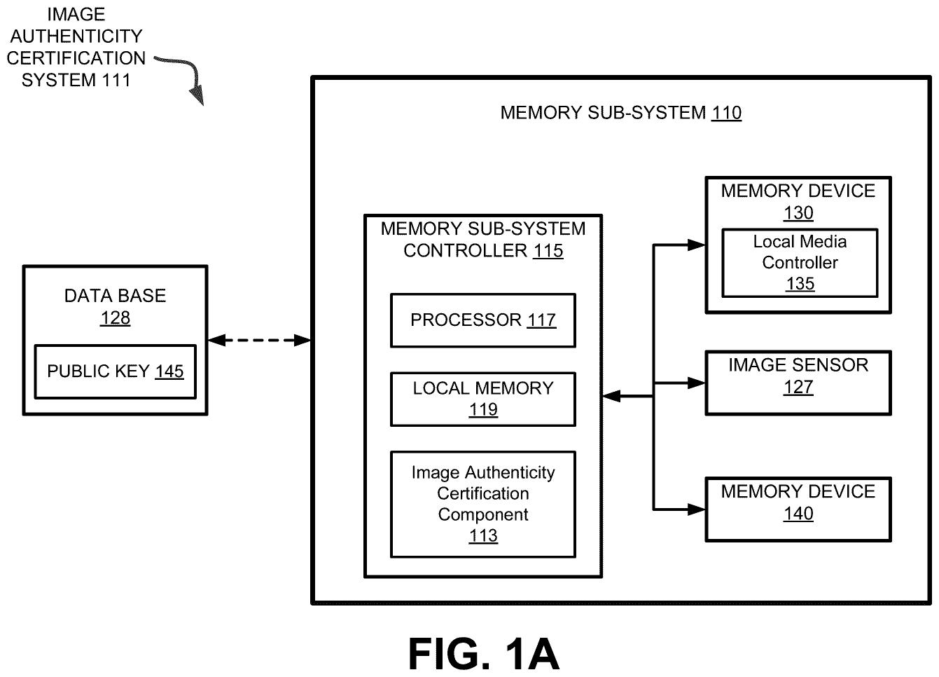

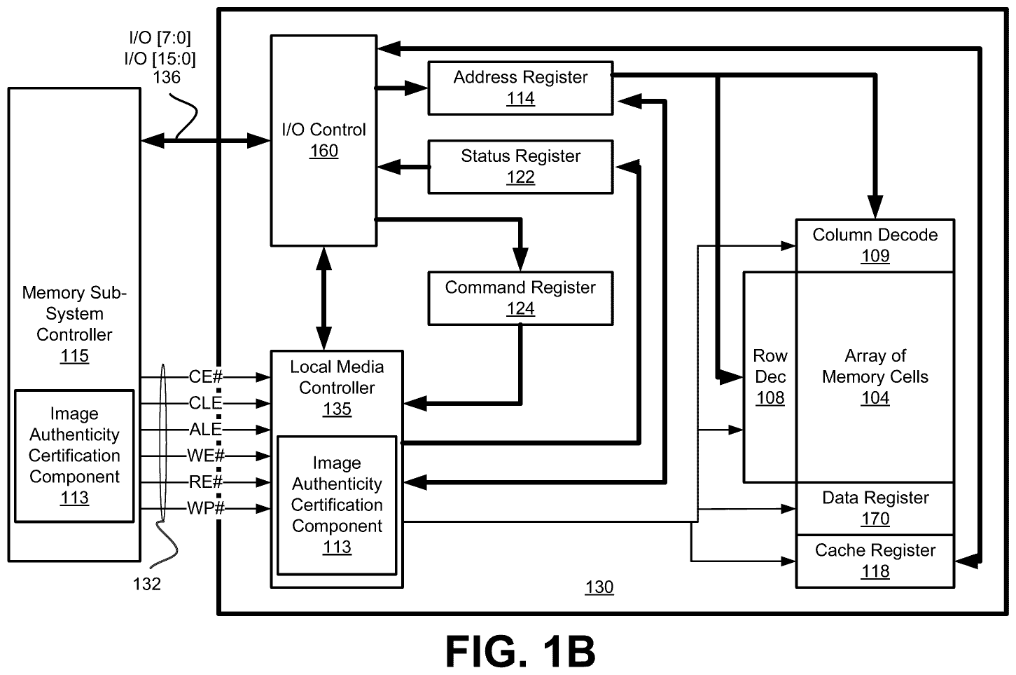

Aspects of the present disclosure are directed to systems and methods for image authenticity certification utilizing a memory sub-system in an integrated image authenticity certification system. A memory sub-system can be a storage device, a memory module, or a combination of a storage device and memory module. Examples of storage devices and memory modules are described below in conjunction with FIGS. 1A and 1B. In general, a host system can utilize a memory sub-system that includes one or more components, such as memory devices that store data. The host system can provide data to be stored at the memory sub-system and can request data to be retrieved from the memory sub-system.

Aspects of the present disclosure are directed to the authentication of digital images. Digital images, as used herein, refer to electronic media that capture a single moment in time. Videos are a series of such images, or frames, shown in sequence, potentially with accompanying audio. The term “digital image” as used herein can include various forms of digital visual representations, including a single image, such as a still image. Additionally, the term “digital image” can include a video stream, which includes a sequence of videoframes (e.g., still images).

Creating, manipulating, or forging fake images has become increasingly accessible with the advancement of artificial intelligence (AI). AI-powered tools enable anyone, regardless of technical expertise, to produce highly convincing fake images. Videos, being a sequence of individual images (e.g., videoframes), can also be forged or faked using these AI technologies. In addition to AI methods, more manual techniques also exist for fabricating fake digital media, such as using photo editing software to alter images or employing video editing tools to splice and manipulate video footage.

Confirming that an image is an original and not an edited copy or forgery helps to verify the veracity of what is depicted. For example, a photo can provide visual evidence of an auto accident, showing exactly what happened, what vehicles were involved, and what damage was caused. Similarly, a video can provide a continuous account of events, offering an even more comprehensive account of an event. Beyond evidentiary contexts, fake can be used in news and social media to spread misinformation, create false narratives, or defame individuals and organizations. The proliferation of such fake content can lead to significant consequences, including public deception, damage to reputations, and undermining trust in media sources. Without the ability to certify the authenticity of an image (or sequence of images), erroneous and fake information can be propagated.

Several free and open-source software programs have been developed to recognize AI-generated content as a countermeasure to the rise of fake images. However, these countermeasures are not entirely effective. One reason for this ineffectiveness is the rapid advancement of AI technology, which often outpaces the development of detection tools. AI algorithms used to create fake images continually evolve, becoming more sophisticated and harder to detect. This results in detection methods becoming obsolete or less effective over time. Moreover, detection software often relies on specific patterns or artifacts left by AI generation processes. As these processes improve, the artifacts become less discernible, reducing the effectiveness of detection. Additionally, these detection measures do not effectively identify manually edited photos and videos, as they may lack the characteristics of AI-generated content.

Aspects of the present disclosure address the above and other deficiencies of existing technologies by implementing systems and methods for image authenticity certification utilizing a memory sub-system in an integrated image authenticity certification system. For example, an image authenticity certification system can provide authentication for digital images. Digital images can include various forms of digital visual representations, including a single image, such as a still image. Additionally, digital images can include a video (e.g., a sequence of still images).

The system can include an image sensor, memory device, and processing device. The image sensor, the memory device, and the processing device can be integrated into a single integrated circuit (IC) package. For example, the image sensor, the memory device, and the processing device can be arranged (e.g., side by side) on a package substrate and can be coupled together using wire bonding or flip-chip bonding techniques. Alternatively, the image sensor, the memory device, and the processing device can be stacked vertically and connected through through-silicon vias (TSVs).

In some embodiments, the image sensor can capture a digital image. In some embodiments, a digital image can include a single image and/or a video stream (e.g., a sequence of images). The processing device can then generate an image signature associated with the digital image using a private key stored in the memory device. The image signature along with the original digital image are saved together in a file for future reference or verification purposes. Additionally, the system may include a database that stores a public key corresponding to an origin ID of the image signature. The origin ID can contain information such as an image sensor identifier, a timestamp, and location data.

The public key can be used to verify the authenticity of the generated image signature. For example, the origin ID can be retrieved from the file containing the origin ID and the original digital image. The public key corresponding to the origin ID can be retrieved from the database. The authenticity of the digital image can be verified by generating a verification signature using the public key and comparing it with the generated image signature. If they match, the digital image is considered authentic; if not, the digital image is deemed inauthentic.

In some embodiments, the private key can be stored in a physically unclonable function (PUF) of the memory device for enhanced security. Further, the memory device can be dynamic random-access memory (DRAM).

Advantages of the present disclosure include, but are not limited to, the ability to confirm that an image or a sequence of digital images (e.g., a video) is an original and not an edited copy or forgery. For example, aspects and implementations of the present disclosure can certify authenticity of visual evidence (e.g., of an auto accident). Aspects and implementations of the present disclosure can prevent use of fake images to spread misinformation, create false narratives, defame individuals and organizations, etc. Aspects and implementations of the present disclosure can certify authenticity of digital images without being outpaced by the development of new image counterfeiting measures. Aspects and implementations of the present disclosure do not rely on specific patterns or artifacts left by AI generation processes and can also identify manually edited images as inauthentic.

FIG. 1A illustrates an example image authenticity certification system 111 that includes a memory sub-system 110, in accordance with some embodiments of the present disclosure. The memory sub-system 110 can include media, such as one or more volatile memory devices (e.g., memory device 140), one or more non-volatile memory devices (e.g., one or more memory device(s) 130), or a combination of such. The memory sub-system 110 can include one or more image sensors (e.g., one or more image sensor(s) 114). In some embodiments, the image sensor 127, the memory device 130, and a memory subsystem controller 115 (e.g. a processing device) are integrated into a package for image authenticity certification. The package can include a package substrate to operatively couple memory subsystem controller 115 to the image sensor 127 and memory device 130.

In some embodiments, the image sensor 127, the memory device 130, and memory subsystem controller 115 can be arranged side by side on the package substrate and can be coupled together, for example, using wire bonding or flip-chip bonding techniques. Alternatively, the image sensor 127, the memory device 130, and memory subsystem controller 115 can be stacked vertically and connected through through-silicon vias (TSVs).

A memory sub-system 110 can be a storage device, a memory module, or a hybrid of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs).

An image sensor 127 can be a standalone device, an integrated module, or a hybrid of an image sensor and processing unit. Examples of standalone image sensors include charge-coupled devices (CCDs) and complementary metal-oxide-semiconductor (CMOS) sensors. Integrated modules might incorporate additional components such as microprocessors or memory elements for image processing and storage, often found in digital cameras and smartphones. Hybrid configurations can combine image sensors with other sensing technologies like infrared or ultrasonic sensors, enhancing functionality in devices such as automotive cameras and advanced security systems. These sensors can vary in form factors, such as wafer-level packaged sensors, chip-on-board sensors, and camera modules with built-in lenses, providing a wide range of applications and performance capabilities.

The image authenticity certification system 111 can be included in a device such as a desktop computer, laptop computer, mobile device, a vehicle (e.g., airplane, drone, train, automobile, or other conveyance), Internet of Things (IoT) enabled device, or any device that includes an image sensor, a memory, and a processing device.

In some embodiments, different types of memory sub-system 110 can be used in image authenticity certification system 111. FIG. 1 illustrates one example of an image authenticity certification system 111 including memory sub-system 110. Memory subsystem 110 includes a processing device (e.g., memory sub-system controller 115) coupled to a memory device (e.g., memory device 130) and to an image sensor (e.g., image sensor 127). As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The memory devices 130, 140 can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM). In some embodiments, memory device 130 is DRAM.

Some examples of non-volatile memory devices (e.g., memory device(s) 130) include negative-and (NAND) type flash memory and write-in-place memory, such as three-dimensional cross-point (“3D cross-point”) memory. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory device(s) 130 can include one or more arrays of memory cells. One type of memory cell, for example, single level cells (SLC) can store one bit per cell. Other types of memory cells, such as multi-level cells (MLCs), triple level cells (TLCs), and quad-level cells (QLCs), can store multiple bits per cell. In some embodiments, each of the memory devices 130 can include one or more arrays of memory cells such as SLCs, MLCs, TLCs, QLCs, or any combination of such. In some embodiments, a particular memory device can include an SLC portion, and an MLC portion, a TLC portion, or a QLC portion of memory cells. The memory cells of the memory devices 130 can be grouped as pages that can refer to a logical unit of the memory device used to store data. With some types of memory (e.g., NAND), pages can be grouped to form blocks.

Although non-volatile memory components such as a 3D cross-point array of non-volatile memory cells and NAND type flash memory (e.g., 2D NAND, 3D NAND) are described, the memory device 130 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), negative-or (NOR) flash memory, electrically erasable programmable read-only memory (EEPROM).

A memory sub-system controller 115 (or controller 115 for simplicity) can communicate with the memory device(s) 130 to perform operations such as reading data, writing data, or erasing data at the memory devices 130 and other such operations. The memory sub-system controller 115 can include hardware such as one or more integrated circuits and/or discrete components, a buffer memory, or a combination thereof. The hardware can include a digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can include a processor 117 (e.g., a processing device) configured to execute instructions stored in a local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the database 128.

In some embodiments, the local memory 119 can include memory registers storing memory pointers, fetched data, etc. The local memory 119 can also include read-only memory (ROM) for storing micro-code. While the example memory sub-system 110 in FIG. 1A has been illustrated as including the memory sub-system controller 115, in another embodiment of the present disclosure, a memory sub-system 110 does not include a memory sub-system controller 115, and can instead rely upon external control (e.g., provided by an external host, or by a processor or controller separate from the memory sub-system).

The memory sub-system controller 115 can be responsible for other operations such as wear leveling operations, garbage collection operations, error detection and error-correcting code (ECC) operations, encryption operations, caching operations, and address translations between a logical address (e.g., logical block address (LBA), namespace) and a physical address (e.g., physical block address) that are associated with the memory device(s) 130.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 115 and decode the address to access the memory device(s) 130.

In some embodiments, the memory device(s) 130 include local media controllers 135 that operate in conjunction with memory sub-system controller 115 to execute operations on one or more memory cells of the memory device(s) 130. An external controller (e.g., memory sub-system controller 115) can externally manage the memory device 130 (e.g., perform media management operations on the memory device(s) 130). In some embodiments, a memory device 130 is a managed memory device, which is a raw memory device (e.g., memory array 104) having control logic (e.g., local controller 135) for media management within the same memory device package. An example of a managed memory device is a managed NAND (MNAND) device. Memory device(s) 130, for example, can each represent a single die having some control logic (e.g., local media controller 135) embodied thereon. In some embodiments, one or more components of memory sub-system 110 can be omitted.

In one embodiment, the memory sub-system 110 includes an image authenticity certification component 113 that can implement image authenticity certification utilizing a memory sub-system 110 in an integrated image authenticity certification system. In an embodiment, one or more portions of the image authenticity certification component 113 of the memory sub-system controller 115 can be included in the local media controller 135.

Image authenticity certification component 113 can implement image authenticity certification utilizing image authenticity certification system 111 and memory sub-system 110. For example, image authenticity certification system 111 can provide authentication for digital images captured by image sensor 127 of memory sub-system 110. Image authenticity certification system 111 (including image sensor 127, memory device 130, and memory sub-system controller 115) can capture a digital image (e.g., using image sensor 127). In some embodiments, a digital image can include a single image and/or a video stream (e.g., a sequence of images). Memory sub-system controller 115 (e.g., using processor 117) can generate an image signature associated with the captured digital image using a private key stored in memory device 130. The image signature along with the original digital image are saved together in a file for future reference or verification purposes.

In some embodiments, memory device 130 can be a DRAM device. In some embodiments, the private key can be stored in a physically unclonable function (PUF) of the memory device 130 for enhanced security. In some embodiments, storing the image signature and the digital image in the file includes appending the image signature to a digital image file (e.g., of the digital image) as metadata.

In some embodiments, image authenticity certification system 111 can include a database 128 that stores a public key 145 corresponding to an origin ID of the image signature. The origin ID can contain information such as an image sensor identifier, a timestamp, and/or location data. The image sensor identifier can specify the image sensor used to capture the image. The timestamp can include the date and time when the image was captured. The location data can indicate, for example, geographical coordinates where the image was captured by image sensor 127. In some embodiments, the timestamp and location data can enhance the ability to certify the authenticity of the image beyond using only an image sensor identifier.

In some embodiments, database 128 can be a centralized or distributed database, ensuring that the public key 145 is readily accessible for authentication purposes. Storing the public key 145 in a database can enhance security by allowing for controlled access and updates, and it can be integrated with other security protocols to prevent unauthorized use or tampering.

The public key 145 can be used to verify the authenticity of the generated image signature. For example, the origin ID can be retrieved from the file containing the origin ID and the original digital image. The public key 145 corresponding to the origin ID can be retrieved from the database. The authenticity of the digital image can be verified by generating a verification signature using the public key 145 and comparing it with the generated image signature. If the verification signature and the image signature match, the digital image is considered authentic. If the verification signature and the image signature do not match, the digital image is considered inauthentic.

Further details with regards to the operations of image authenticity certification component 113 are described below.

FIG. 1B is a simplified block diagram of a first apparatus, in the form of a memory device 130, in communication with a second apparatus, in the form of a memory sub-system controller 115 of a memory sub-system (e.g., memory sub-system 110 of FIG. 1A), according to an embodiment. Some examples of image sensors include CCDs, CMOS sensors, infrared sensors, ultrasonic sensors, time-of-flight (ToF) sensors, and hybrid sensors combining multiple sensing technologies, and the like. The memory sub-system controller 115 (e.g., a controller external to the memory device 130), may be a memory controller or other external host device.

Memory device(s) 130 includes an array of memory cells 104 logically arranged in rows and columns. Memory cells of a logical row are connected to the same access line (e.g., a wordline) while memory cells of a logical column are selectively connected to the same data line (e.g., a bitline). A single access line may be associated with more than one logical row of memory cells and a single data line may be associated with more than one logical column. Memory cells of at least a portion of array of memory cells 104 are capable of being programmed to one of at least two target data states.

Row decode circuitry 108 and column decode circuitry 109 are provided to decode address signals. Address signals are received and decoded to access the array of memory cells 104. Memory device 130 also includes input/output (I/O) control circuitry 160 to manage input of commands, addresses and data to the memory device 130 as well as output of data and status information from the memory device(s) 130. An address register 114 is in communication with I/O control circuitry 160 and row decode circuitry 108 and column decode circuitry 109 to latch the address signals prior to decoding. A command register 124 is in communication with I/O control circuitry 160 and local media controller 135 to latch incoming commands.

A controller (e.g., the local media controller 135 internal to the memory device 130) controls access to the array of memory cells 104 in response to the commands and generates status information for the external memory sub-system controller 115, i.e., the local media controller 135 is configured to perform access operations (e.g., read operations, programming operations and/or erase operations) on the array of memory cells 104. The local media controller 135 is in communication with row decode circuitry 108 and column decode circuitry 109 to control the row decode circuitry 108 and column decode circuitry 109 in response to the addresses. In one embodiment, the memory sub-system controller 115 and the local media controller 135 include portions of the image authenticity certification component 113 which are configured to enable communication between the memory sub-system controller 115 and the local media controller 135 to perform the steps and operations associated with image authenticity certification of one or more images captured by an image sensor that can be operatively coupled to memory subsystem controller 115, in accordance with embodiments of the present application.

The local media controller 135 is also in communication with a cache register 118. Cache register 118 latches data, either incoming or outgoing, as directed by the local media controller 135 to temporarily store data while the array of memory cells 104 is busy writing or reading, respectively, other data. During a program operation (e.g., write operation), data may be passed from the cache register 118 to the data register 170 for transfer to the array of memory cells 104; then new data may be latched in the cache register 118 from the I/O control circuitry 160. During a read operation, data may be passed from the cache register 118 to the I/O control circuitry 160 for output to the memory sub-system controller 115; then new data may be passed from the data register 170 to the cache register 118. The cache register 118 and/or the data register 170 may form (e.g., may form a portion of) a page buffer of the memory device 130. A page buffer may further include sensing devices (not shown in FIG. 1B) to sense a data state of a memory cell of the array of memory cells 104, e.g., by sensing a state of a data line connected to that memory cell. A status register 122 may be in communication with I/O control circuitry 160 and the local memory controller 135 to latch the status information for output to the memory sub-system controller 115.

Memory device(s) 130 receives control signals at the memory sub-system controller 115 from the local media controller 135 over a control link 132. For example, the control signals can include a chip enable signal CE #, a command latch enable signal CLE, an address latch enable signal ALE, a write enable signal WE #, a read enable signal RE #, and a write protect signal WP #. Additional or alternative control signals (not shown) may be further received over control link 132 depending upon the nature of the memory device 130. In one embodiment, memory device 130 receives command signals (which represent commands), address signals (which represent addresses), and data signals (which represent data) from the memory sub-system controller 115 over a multiplexed input/output (I/O) bus 136 and outputs data to the memory sub-system controller 115 over I/O bus 136.

For example, the commands may be received over input/output (I/O) pins [7:0] of I/O bus 136 at I/O control circuitry 160 and may then be written into command register 124. The addresses may be received over input/output (I/O) pins [7:0] of I/O bus 136 at I/O control circuitry 160 and may then be written into address register 114. The data may be received over input/output (I/O) pins [7:0] for an 8-bit device or input/output (I/O) pins [15:0] for a 16-bit device at I/O control circuitry 160 and then may be written into cache register 118. The data may be subsequently written into data register 170 for programming the array of memory cells 104.

In an embodiment, cache register 118 may be omitted, and the data may be written directly into data register 170. Data may also be output over input/output (I/O) pins [7:0] for an 8-bit device or input/output (I/O) pins [15:0] for a 16-bit device. Although reference may be made to I/O pins, they may include any conductive node providing for electrical connection to the memory device 130 by an external device (e.g., the memory sub-system controller 115), such as conductive pads or conductive bumps as are commonly used.

It will be appreciated by those skilled in the art that additional circuitry and signals can be provided, and that the memory device 130 of FIGS. 1A-1B has been simplified. It should be recognized that the functionality of the various block components is described with reference to FIGS. 1A-1B may not necessarily be segregated to distinct components or component portions of an integrated circuit device. For example, a single component or component portion of an integrated circuit device could be adapted to perform the functionality of more than one block component of FIGS. 1A-1B. Alternatively, one or more components or component portions of an integrated circuit device could be combined to perform the functionality of a single block component of FIGS. 1A-1B. Additionally, while specific I/O pins are described in accordance with popular conventions for receipt and output of the various signals, it is noted that other combinations or numbers of I/O pins (or other I/O node structures) may be used in the various embodiments.

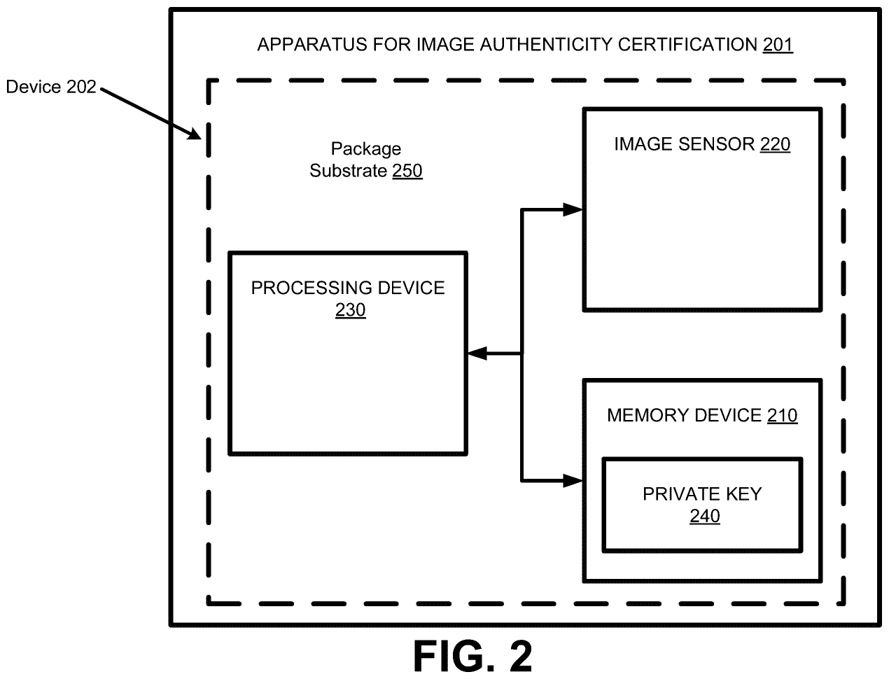

FIG. 2 illustrates an example apparatus for image authenticity certification including a memory sub-system, in accordance with some embodiments of the present disclosure.

In some embodiments, an apparatus for image authenticity certification 201 includes a device 202 to certify authenticity of digital images. The device 202 includes an image sensor 220 configured to capture digital images, a memory device 210 configured to store data associated with the digital images, and a processing device 230 operatively coupled to the memory device 210 and to the image sensor 220. In some embodiments, image sensor 220, memory device 210, and processing device 230 can be integrated into a single package. For example, image sensor 220, memory device 210, and processing device 230 can be arranged side by side on a package substrate 250 and can be coupled together (e.g., using wire bonding, flip-chip bonding techniques, etc.). Alternatively, image sensor 220, memory device 210, and processing device 230 can be stacked vertically and connected through through-silicon vias (TSVs).

The processing device 230 is to cause a digital image to be captured by the image sensor. In some embodiments, a digital image can include a single image and/or a video stream (e.g., a sequence of images).

The processing device 230 is further to retrieve, from the memory device, a private key 240. In some embodiments, the private key 240 can be stored in a PUF of the memory device 210. In some embodiments, the memory device 210 can include a DRAM device.

The processing device 230 is further to generate, using the private key 240, an image signature for the digital image.

In some embodiments, the image signature includes an origin ID. A public key corresponding to the origin ID of the image signature can be used to verify that the image signature is authentic. In some embodiments, the public key is stored in a database. The database can be a centralized or distributed database, ensuring that the public key is readily accessible for authentication purposes. Storing the public key in a database enhances security by allowing for controlled access and updates, and it can be integrated with other security protocols to prevent unauthorized use or tampering.

In some embodiments, the origin ID includes an image sensor identifier, a timestamp, and location data. The image sensor identifier specifies the hardware (e.g., image sensor) used to capture the image, while the timestamp records the exact date and time of capture. Location data provides the geographical coordinates of where the image was captured. Timestamp and location data enhances the ability to certify the image's authenticity, making it harder to falsify or manipulate.

The processing device 230 is further to store, in a file, the image signature and the digital image. In some embodiments, storing the image signature and the digital image in the file includes appending the image signature to a digital image file as metadata. In some embodiments, processing device 230 can retrieve the origin ID from the file, retrieve the public key from the database using the origin ID, and verify that the image signature is authentic using the public key. Verifying that the image signature is authentic using the public key can include generating a verification signature using the public key and determining whether the verification signature matches the image signature. The processing device 230 can determine that the digital image is authentic in response to determining that the verification signature matches the image signature. The processing device 230 can determine that the digital image is not authentic in response to determining that the verification signature does not match the image signature.

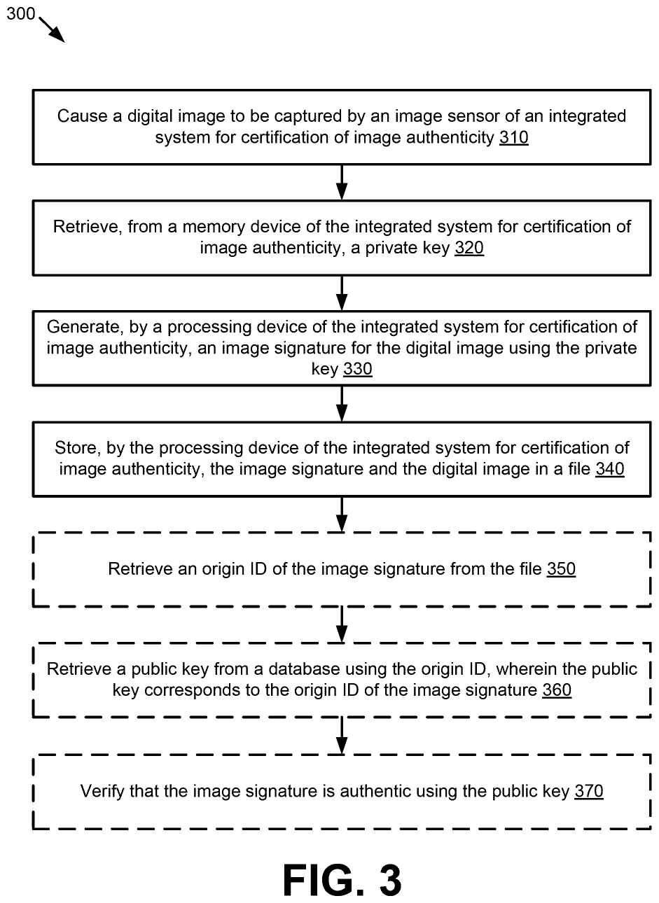

FIG. 3 is a flow diagram of an example method implementing image authenticity certification using a memory sub-system, in accordance with one or more embodiments of the present disclosure. The method 300 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 300 is performed by image authenticity certification component 113 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 310, the processing logic may cause a digital image to be captured by an image sensor of an integrated system for image authenticity certification. In some embodiments, a digital image can include a single image and/or a video stream (e.g., a sequence of images).

In some embodiments, an image sensor can include standalone devices like CCDs and CMOS sensors, as well as integrated modules that include additional components such as microprocessors or memory elements for image processing and storage. In some embodiments, image sensors can be combined with other sensing technologies like infrared or ultrasonic sensors, enhancing functionality. Image sensors can come in various form factors, such as wafer-level packaged sensors, chip-on-board sensors, camera modules with built-in lenses, etc.

At operation 320, the processing logic can retrieve, from a memory device of the integrated system for image authenticity certification, a private key. In some embodiments, the private key can be stored in a physically unclonable function (PUF) of the memory device. In some embodiments, the memory device includes a dynamic random-access memory (DRAM) device.

In some embodiments, the image sensor, the memory device, and a processing device can be integrated into a package for image authenticity certification. The package can include a package substrate to operatively couple the processing device to the image sensor and the memory device. For example, the image sensor, the memory device, and the processing device can be arranged side by side on the package substrate and can be coupled together using wire bonding or flip-chip bonding techniques. Alternatively, the image sensor, the memory device, and the processing device can be stacked vertically and connected through through-silicon vias (TSVs). In a 3D integrated configuration, each die (corresponding to the image sensor, the memory device, and the processing device) is placed on top of another, and TSVs are used to create vertical electrical connections through the silicon dies. This stacking method can reduce the footprint of the package. Further TSVs provide high-speed, high-bandwidth interconnections between the stacked dies.

TSVs can further enhance the security of an integrated image authenticity certification system by making physical attacks, such as unsoldering and breaching, significantly more challenging. TSVs are embedded within the silicon dies, creating vertical connections that are difficult to access without damaging the entire stack. This intricate structure and reduced accessibility mean that attackers cannot easily probe or tamper with individual connections. Additionally, the high integration density of TSV-based systems increases the complexity of any potential attack, as manipulating one connection without affecting others is technically demanding. The robust thermal and mechanical stability of TSVs further complicates any unsoldering attempts, as precise control is required to avoid damaging the TSV structures. Consequently, TSVs provide a more secure and tamper-resistant method of integrating components in an image authenticity certification system.

At operation 330, the processing logic can generate, by a processing device of the integrated system for image authenticity certification, an image signature for the digital image using the private key.

At operation 340, the processing logic can store, by the processing device of the integrated system for image authenticity certification, the image signature and the digital image in a file. In some embodiments, storing the image signature and the digital image in the file includes appending the image signature to a digital image file (e.g., a digital image file of the digital image) as metadata. In some embodiments, the digital image file can be compressed before embedding the image signature in the digital image file of the digital image or appending the image signature to the digital image file of the digital image.

In some embodiments, the image signature includes an origin identification (ID). In some embodiments, the origin ID includes one or more of an image sensor identifier, a timestamp, and location data. The image sensor identifier can specify the particular image sensor used to capture the image, providing a unique reference to the hardware (e.g., image sensor) that captured the image. The timestamp can include the precise date and time when the image was captured. The location data can indicate, for example, the geographical coordinates where the image was captured by image sensor 127, offering spatial context. In some embodiments, the combination of the timestamp and location data can significantly enhance the ability to certify the authenticity of the image. This additional information can help verify the circumstances under which the image was taken, making it more difficult to falsify or manipulate the image without detection. Furthermore, integrating these details can aid in tracking and tracing the image's origin.

At operation 350, the processing logic can retrieve the origin ID from the file.

At operation 360, the processing logic can retrieve a public key from a database using the origin ID. The public key corresponds to the origin ID of the image signature.

At operation 370, the processing logic can verify that the image signature is authentic using the public key.

In some embodiments, verifying that the image signature is authentic using the public key includes generating a verification signature using the public key and determining whether the verification signature matches the image signature. The processing logic can determine that the digital image is authentic in response to determining that the verification signature matches the image signature. Alternatively, the processing logic can determine that the digital image is not authentic in response to determining that the verification signature does not match the image signature.

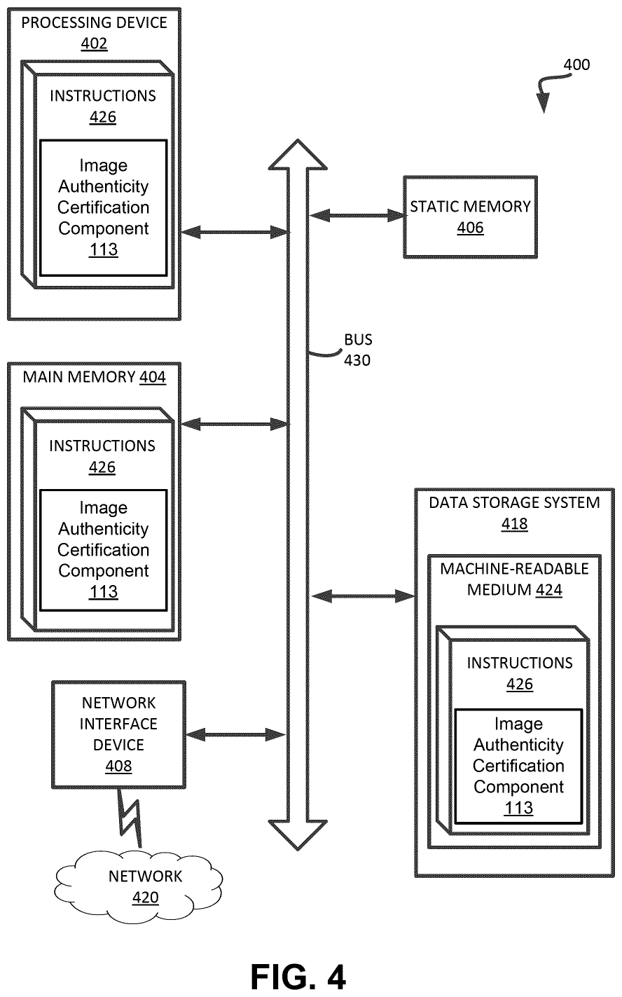

FIG. 4 illustrates an example machine of a computer system 400 within which a set of instructions, for causing the machine to perform any one or more of the methodologies discussed herein, can be executed. In some embodiments, the computer system 400 can correspond to a host system that includes, is coupled to, or utilizes a memory sub-system (e.g., the memory sub-system 110 of FIGS. 1A and 1B) or can be used to perform the operations of a controller (e.g., to execute an operating system to perform operations corresponding to the image authenticity certification component 113 of FIGS. 1A and 1B). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 400 includes a processing device 402, a main memory 404 (e.g., read-only memory (ROM), flash memory, dynamic random access memory (DRAM) such as synchronous DRAM (SDRAM) or Rambus DRAM (RDRAM), etc.), a static memory 406 (e.g., flash memory, static random access memory (SRAM), etc.), and a data storage system 418, which communicate with each other via a bus 430.

Processing device 402 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 402 can also be one or more special-purpose processing devices such as an application specific integrated circuit (ASIC), a field programmable gate array (FPGA), a digital signal processor (DSP), network processor, or the like. The processing device 402 is configured to execute instructions 426 for performing the operations and steps discussed herein. The computer system 400 can further include a network interface device 408 to communicate over the network 420.

The data storage system 418 can include a machine-readable storage medium 424 (also known as a computer-readable medium) on which is stored one or more sets of instructions 426 or software embodying any one or more of the methodologies or functions described herein. The instructions 426 can also reside, completely or at least partially, within the main memory 404 and/or within the processing device 402 during execution thereof by the computer system 400, the main memory 404 and the processing device 402 also constituting machine-readable storage media. The machine-readable storage medium 424, data storage system 418, and/or main memory 404 can correspond to the memory sub-system 110 of FIGS. 1A and 1B.

In one embodiment, the instructions 426 include instructions to implement functionality corresponding to the image authenticity certification component 113 of FIGS. 1A and 1B). While the machine-readable storage medium 424 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A system comprising:
an image sensor;
a memory device; and
a processing device operatively coupled to the memory device and to the image sensor, wherein the image sensor, the memory device, and the processing device are integrated into an integrated circuit (IC) package for image authenticity certification, and wherein the processing device is to perform operations comprising:
causing a digital image to be captured by the image sensor;
retrieving, from the memory device, a private key;
generating, using the private key, an image signature for the digital image; and
storing, in a file, the image signature and the digital image.

2. The system of claim 1, wherein the image signature comprises an origin identification (ID), and wherein the system further comprises:
a database storing a public key corresponding to the origin ID of the image signature, wherein the public key is used to verify that the image signature is authentic.

3. The system of claim 2, wherein the origin ID comprises one or more of an image sensor identifier, a timestamp, and location data.

4. The system of claim 1, wherein the private key is stored in a physically unclonable function (PUF) of the memory device.

5. The system of claim 1, wherein the memory device comprises a dynamic random-access memory (DRAM) device.

6. The system of claim 1, wherein storing the image signature and the digital image in the file comprises appending the image signature to a digital image file as metadata.

7. A method comprising:
causing a digital image to be captured by an image sensor of an integrated system for image authenticity certification;
retrieving, from a memory device of the integrated system for image authenticity certification, a private key;
generating, by a processing device of the integrated system for image authenticity certification, an image signature for the digital image using the private key; and
storing, by the processing device of the integrated system for image authenticity certification, the image signature and the digital image in a file.

8. The method of claim 7, wherein the image signature comprises an origin identification (ID), the method further comprising:
retrieving the origin ID from the file;
retrieving a public key from a database using the origin ID, wherein the public key corresponds to the origin ID of the image signature; and
verifying that the image signature is authentic using the public key.

9. The method of claim 8, wherein the origin ID comprises one or more of an image sensor identifier, a timestamp, and location data.

10. The method of claim 8, wherein verifying that the image signature is authentic using the public key comprises:
generating a verification signature using the public key; and
determining whether the verification signature matches the image signature.

11. The method of claim 10, further comprising:
determining that the digital image is authentic in response to determining that the verification signature matches the image signature.

12. The method of claim 10, further comprising:
determining that the digital image is not authentic in response to determining that the verification signature does not match the image signature.

13. The method of claim 7, wherein the private key is stored in a physically unclonable function (PUF) of the memory device.

14. The method of claim 7, wherein the memory device comprises a dynamic random-access memory (DRAM) device.

15. The method of claim 7, wherein storing the image signature and the digital image in the file comprises appending the image signature to a digital image file as metadata.

16. A apparatus comprising:
a device to certify authenticity of digital images, wherein the device comprises:
an image sensor configured to capture digital images;
a memory device configured to store data associated with the digital images; and
a processing device operatively coupled to the memory device and to the image sensor, and wherein the processing device is to:
cause a digital image to be captured by the image sensor;
retrieve, from the memory device, a private key;
generate, using the private key, an image signature for the digital image; and
store, in a file, the image signature and the digital image.

17. The apparatus of claim 16, wherein the image signature comprises an origin identification (ID), and wherein a public key corresponding to the origin ID of the image signature is used to verify that the image signature is authentic.

18. The apparatus of claim 17, wherein the origin ID comprises one or more of an image sensor identifier, a timestamp, and location data.

19. The apparatus of claim 17, wherein the private key is stored in a physically unclonable function (PUF) of the memory device.

20. The apparatus of claim 17, wherein the memory device comprises a dynamic random-access memory (DRAM) device.
